(19) United States
(12) Patent Application Publication
(10) Pub. No.: US 2008/0276874 A1
(43) Pub. Date: Nov. 13, 2008

(54) FEEDER AND PERCH

(76) Inventor: Graham Charles Evans, Canterbury (GB)

Correspondence Address: GAUTHIER & CONNORS, LLP, 225 FRANKLIN STREET, SUITE 2300, BOSTON, MA, 02110, US

(21) Appl. No.: 12/114,887

(22) Filed: May 5, 2008

(30) Foreign Application Priority Data
May 8, 2007 (GB) 0708830.5

(51) Int. Cl. A01K 39/012

(52) U.S. Cl. 119/57.8

(57) ABSTRACT

A feeder is disclosed comprising a receptacle for feed, a post and a removable perch for an animal, especially a bird, to stand on; wherein the removable perch is removably attached to the feeder by engaging with the post during attachment.

### PRIORITY INFORMATION

The present application claims priority to Great Britain Patent Application No. 0708830.5, filed on May 8, 2007, all of which is incorporated herein in its entirety.

### BACKGROUND OF THE INVENTION

This invention relates to a feeder having a receptacle for feed and a perch for an animal (especially a bird) to stand on.

Bird feeders are of course known and, at the time of writing, a large selection can be purchased from the following website: http://www.jacobijayne.co.uk.

Known configurations of perch include posts and rings which are either permanently attached to or moulded integral with a feeder.

### SUMMARY OF INVENTION

In accordance with the present invention, there is provided a feeder comprising a receptacle for feed, a post and a removable perch; wherein the removable perch is removably attached to the feeder by engaging with the post during attachment.

The inventor has realised that conventional feeders suffer from the disadvantage that one size of perch does not necessarily fit all. By providing a feeder for which the perch may be removably attached, one may for example replace one perch with another which may be more attractive to certain birds of a particular size or species including for reasons of comfort and security. Furthermore, a perch configured to be removably attached to such a feeder enables the present invention to be implemented by retro-fitting conventional feeders with a post-type perch.

Accordingly, further provided in accordance with the present invention is a removable perch configured to be removably attached to such a feeder by engaging with its post.

Yet further provided in accordance with the present invention is a package for sale comprising a feeder having a receptacle for food, a post, a removable perch which may be removably attached to the feeder, and at least one spare removable perch which may also be removably attached to the feeder. Ideally, the removable perches are of different sizes.

### BRIEF DESCRIPTION OF DRAWINGS

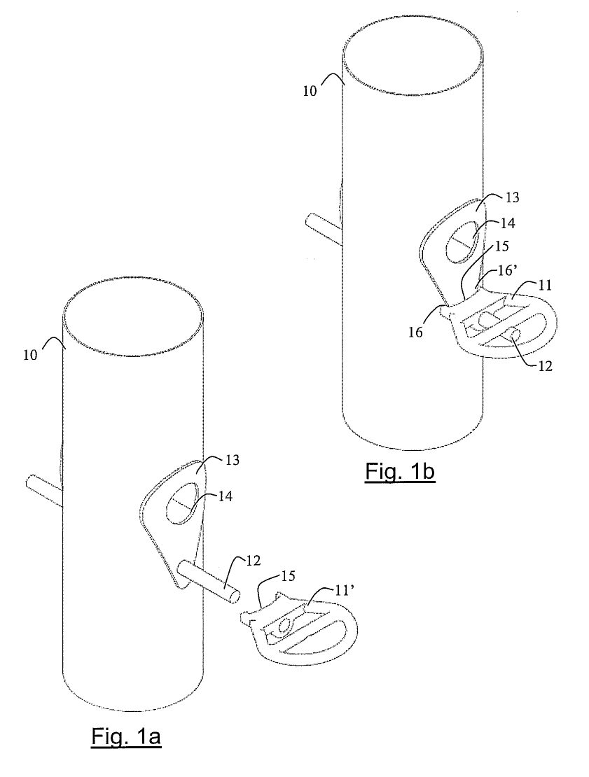

The invention will now be described, by way of example only, with reference to FIGS. 1a and 1b which show, schematically, a bird feeder according to the present invention.

### DETAILED DESCRIPTION OF THE INVENTION

Referring to FIGS. 1a and 1b, a cylindrical bird feeder 10 is shown forming a receptacle for bird feed (not shown). The feeder supports a ring-type perch 11 on which a bird may land and feed. The perch is connected to and supported by the feeder using a post 12 which passes through the feeder, perpendicular to its cylindrical axis.

In FIG. 1a, the ring-type perch 11 is shown detached from the bird feeder 10. Whilst detached, the post 12 acts a perch.

In FIG. 1b, the ring-type perch 11 is shown attached to bird feeder 10, mounted on the post 12. The feeder has a reinforcement 13 attached to the cylindrical body of the feeder and which envelops a region around the feed hole 14 and the post 12.

The ring-type perch 11 is provided with a recess 15 which abuts with the reinforcement 13 at positions 16, 16′ either side of the reinforcement so as to prevent the perch from rotating about the post when the perch is fully engaged.

What is claimed is:

1. A feeder comprising a receptacle for feed, a post and a removable perch; wherein the removable perch is removably attached to the feeder by engaging with the post during attachment.

2. A feeder according to claim 1 wherein the post, in the absence of the removable perch, may itself function as a perch.

3. A feeder according to claim 1 wherein, when the removable perch is fully engaged with the post, the perch abuts the feeder so as to prevent rotation of the removable perch about the post.

4. A removable perch configured to be removably attached to a feeder by engaging with a post of the feeder.

5. A package for sale comprising a feeder having a receptacle for food, a post, a removable perch which may be removably attached to the feeder, and at least one spare removable perch which may also be removably attached to the feeder.

6. A package as claimed in claim 5 wherein the removable perches are of different sizes.
